(19) United States
(12) Patent Application Publication
(10) Pub. No.: US 2007/0209538 A1
(43) Pub. Date: Sep. 13, 2007

(54) Rubber sleeve and method for producing it

(75) Inventors: Alfons Grieser, Sielenbach (DE); Eduard Hoffmann, Bobingen (DE); Christian Sameit, Bonstetten (DE); Georg Schmid, Neusass (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG, Offenbach am Main (DE)

(21) Appl. No.: 11/715,733

(22) Filed: Mar. 8, 2007

(30) Foreign Application Priority Data
Mar. 9, 2006 (DE) 10 2006 010 878.7

(51) Int. Cl. B41F 27/06

(52) U.S. Cl. 101/376

(57) ABSTRACT

A rubber sleeve for a printing press includes, an inner layer, which is formed as a base layer, and an outer layer, which is formed as a functional layer and is used to carry out the printing process. The base layer and the functional layer are produced by cylindrical shaping of separate, flat blanks, and arranged so that the abutting edges of the base layer and the abutting edges of the functional layer are circumferentially offset from each other.

### BACKGROUND OF THE INVENTION

1. Field of the Invention

The invention concerns a rubber sleeve for a printing press. The invention also concerns a method for producing a rubber sleeve for a printing press.

2. Description of the Related Art

Basically two practical methods for producing a rubber sleeve are known. According to a first practical method for producing a rubber sleeve, a rigid carrier sleeve made of metal or composite material is provided, which is closed and continuous in the circumferential direction, then layers of the rubber sleeve are applied to this carrier sleeve one after another. This is preferably accomplished by a so-called spreading process. According to a second practical method for producing a rubber sleeve, a rigid carrier sleeve made of metal or composite material is provided, which is closed and continuous in the circumferential direction, and, in addition, a rubber blanket is provided as a semifinished product, which is fabricated with at least two layers and is wound around the rigid carrier sleeve and firmly joined with the rigid carrier sleeve.

Accordingly, state-of-the-art rubber sleeves of these types always have a rigid carrier sleeve made of metal or composite material, which is closed in the circumferential direction or continuous in the circumferential direction. This results in high manufacturing costs for a rubber sleeve.

### SUMMARY OF THE INVENTION

The rubber sleeve of the invention is fabricated with at least two layers, namely, an inner layer, which is formed as a base layer, and an outer layer, which is formed as a functional layer and is used to carry out the printing process, such that the base layer and the functional layer are produced by cylindrical shaping of separate, flat blanks, and such that the abutting edges of the base layer and the abutting edges of the functional layer do not coincide but rather are offset from each other.

A rigid carrier sleeve that is closed in the circumferential direction or continuous in the circumferential direction is entirely unnecessary in the rubber sleeve of the invention. The rubber sleeve of the invention is formed, instead, by cylindrical shaping of at least two flat blanks, such that a first flat blank forms the base layer and a second flat blank forms the functional layer of the rubber sleeve of the invention. The flat blanks for the base layer and the functional layer can be cut from continuous webs, which can be produced highly economically in a continuous process. The rubber sleeves of the invention can be manufactured by simple means and thus at low cost.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a perspective view of a first embodiment of a rubber sleeve of the invention for a printing press;

FIG. 2 shows a perspective view of a second embodiment of a rubber sleeve of the invention for a printing press; and

FIG. 3 shows a perspective view of a third embodiment of a rubber sleeve of the invention for a printing press.

### DETAILED DESCRIPTION OF THE PRESENTLY PREFERRED EMBODIMENTS

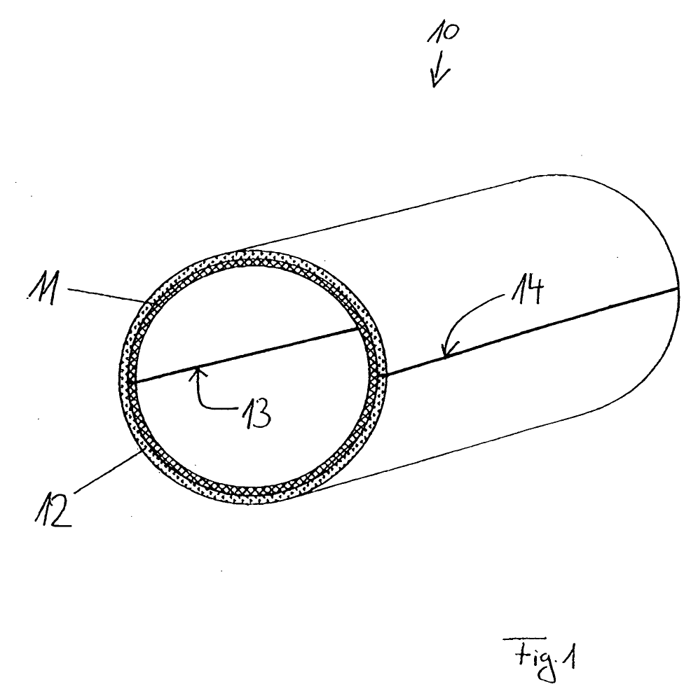

FIG. 1 is a schematic representation of a rubber sleeve 10 of the invention for a printing press. The rubber sleeve 10 is fabricated with at least two layers, namely, an inner layer or base layer 11 and an outer layer or functional layer 12 for carrying out the printing process. The functional layer 12 serves the purpose of transferring printing ink to a printed product.

The base layer 11 and the functional layer 12 of the rubber sleeve 10 of the invention are produced by cylindrical or hollow-cylindrical or tubular shaping of separate, flat blanks, such that during the shaping of the flat blanks, the resulting abutting edges 13 of the base layer 11 and abutting edges 14 of the functional layer 12 do not coincide but rather are offset from each other.

In the specific embodiment illustrated in FIG. 1, the abutting edges 13, 14 of the base layer 11 and the functional layer 12 run parallel to the longitudinal center axis of the rubber sleeve 10. However, the abutting edges 14 of the functional layer 12 are offset by about 180° from the abutting edges 13 of the base layer 11, so that the two sets of abutting edges 13, 14 are approximately diametrically opposite each other on the rubber sleeve 10.

It should be noted that the abutting edges 13 and 14 of the base layer 11 and the functional layer 12 can be offset from each other by a different angle, which is preferably 10° to 350°, more preferably 40° to 320°, and even more preferably 90° to 270°. The variant shown in FIG. 1, in which the abutting edges 13, 14 of the base layer 11 and the functional layer 12 are offset from each other by about 180°, is especially preferred.

As has already been mentioned, the base layer 11 and the functional layer 12 of the rubber sleeve 10 of the invention are produced by cylindrical shaping of separate, flat blanks.

The flat blanks are preferably shaped in such a way that the abutting edges 13 of the base layer 11 and the abutting edges 14 of the functional layer 12 abut with no gap between them. In this regard, the abutting edges 13 of the base layer 11 are not joined, and the abutting edges 14 of the functional layer 12 are not joined. In other words, the base layer 11 and the functional layer 12 of the rubber sleeve 10 are not closed in the circumferential direction and are not continuous in the circumferential direction.

However, it is also possible for a gap to be present between the abutting edges of the base layer and/or between the abutting edges of the functional layer. This gap is preferably filled with a material, e.g., a sealing material. However, the abutting edges 13 of the base layer 11 and the abutting edges 14 of the functional layer 12 are not firmly joined by the sealing material. In this case as well, the base layer 11 and the functional layer 12 of the rubber sleeve 10 are not closed in the circumferential direction and are not continuous in the circumferential direction.

The base layer 11 and the functional layer 12 of the rubber sleeve 10 of the invention are joined to each other, preferably by adhesive bonding, welding, or vulcanizing.

However, the base layer 11 and the functional layer 12 can also be joined to each other by any other joining method. When the functional layer 12 has been adhesively bonded with the base layer 11, a bonding layer, i.e., a layer of adhesive, is then positioned between the radially outer surface of the base layer and the radially inner surface of the functional layer.

The blank for the base layer 11 preferably consists of a plastic, a fiber composite material, or a metal. The blank for the functional layer 12 preferably consists of a rubber blanket.

The rubber sleeve 10 of the invention is produced by first producing a flat blank for the base layer 11 of the rubber sleeve 10. In a second step of the method of the invention, the flat blank for the base layer 11 is formed into a cylindrical shape but without the abutting edges 13 of the base layer 11 being joined. The cylindrical shaping of the flat blank for the base layer 11 is performed on a production cylinder. The cylindrically shaped blank for the base layer is preferably held on the production cylinder by negative pressure (suction).

This is followed by a third step of the method of the invention, in which a flat blank for the functional layer 12 of the rubber sleeve 10 of the invention is produced, and then in a fourth step the flat blank for the functional layer is formed into a cylindrical shape around the cylindrically shaped base layer 11, which is being held on the production cylinder. Once again, the abutting edges 14 of the functional layer 12 are not joined at this point. The forming of the blank for the functional layer 12 into a cylindrical shape around the already cylindrically shaped blank of the base layer 11 is carried out in such a way that the abutting edges 13 of the base layer 11 and the abutting edges 14 of the functional layer 12 do not coincide but rather are offset from each other.

Before the cylindrical shaping of the flat blank of the functional layer 12 around the already cylindrically shaped base layer 11, an adhesive is preferably applied on the radially outer surface of the base layer 11, so that when the flat blank of the functional layer 12 is cylindrically shaped, the functional layer 12 is joined with the already cylindrically shaped base layer 11.

Due to the fact that the abutting edges of the base layer 11 and the functional layer 12 are offset from each other, the two layers 11 and 12 stabilize each other without any necessity of joining the abutting edges of the base layer 11 and functional layer 12.

Finally, joint regions or gaps formed between the abutting edges 13 of the base layer 11 and between the abutting edges 14 of the functional layer 12 are possibly filled with a material, e.g., a sealing material, but without establishing a firm connection between the abutting edges. A sealing material for this purpose is preferably compressible.

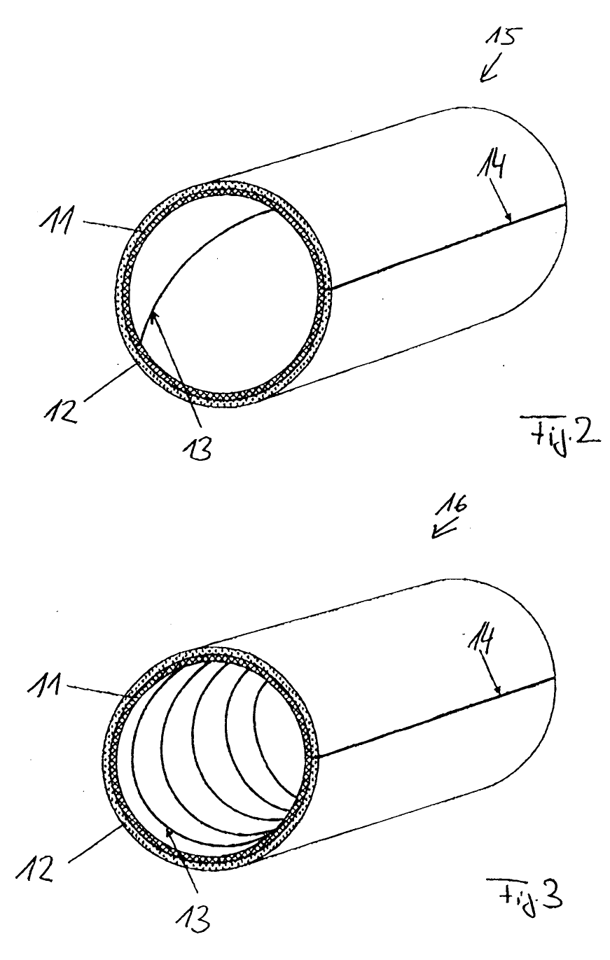

FIGS. 2 and 3 show two further embodiments of a rubber sleeve 15 and 16, respectively. The basic structure of the rubber sleeves 15 and 16 according to FIGS. 2 and 3, respectively, is the same as the structure of the rubber sleeve 10 shown in FIG. 1. Therefore, to avoid unnecessary repetition, the same reference numbers are used for elements which are the same, and we shall discuss only those details by which the embodiments shown in FIGS. 2 and 3 differ from the embodiment shown in FIG. 1.

For example, as was mentioned above, in the specific embodiment illustrated in FIG. 1, the abutting edges 13 of the base layer 11 and the abutting edges 14 of the functional layer 12 both run parallel to the longitudinal center axis of the rubber sleeve 10.

In the specific embodiment illustrated in FIG. 2, on the other hand, only the abutting edges 14 of the functional layer 12 run parallel to the longitudinal center axis of the rubber sleeve 10. However, the abutting edges 13 of the base layer 11 run at an angle to the longitudinal center axis of the rubber sleeve 10. This angle is relatively small or acute in the present case.

In the specific embodiment of FIG. 3, once again only the abutting edges 14 of the functional layer 12 run parallel to the longitudinal center axis of the rubber sleeve 10. Here too, the abutting edges 13 of the base layer 11 run at an angle to the longitudinal center axis of the rubber sleeve 10. This angle is relatively large (closer to 90°) in this case, so that the base layer 11 is formed as a cylinder by several helical windings of a narrow strip.

The base layer 11 and the functional layer 12 in the specific embodiments of FIGS. 2 and 3 are thus also formed by cylindrical shaping of separate, flat blanks, and the abutting edges 13,14 of the base layer 11 and the functional layer 12 do not coincide but rather are offset from each other.

The rubber sleeve of the invention is distinguished by its simple construction and can be produced by simple and inexpensive means. The rubber sleeve of the invention is used to transfer printing ink to a printed product in offset printing.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What we claim is:

1. A rubber sleeve for a printing press, said sleeve comprising:
an inner layer produced by forming a flat blank into a cylindrically shaped base layer having abutting edges; and
an outer layer produced by forming a flat blank into a cylindrically shaped functional layer having abutting edges, said base layer and said functional layer having a common axis, the abutting edges of the respective layers being circumferentially offset from each other.

2. The rubber sleeve of claim 1 wherein the abutting edges of the base layer have no gap between them.

3. The rubber sleeve of claim 1 wherein the abutting edges of the base layer are not joined.

4. The rubber sleeve of claim 1 wherein the abutting edges of the base layer have a gap between them.

5. The rubber sleeve of claim 4 wherein said gap is filled with a sealing material which does not firmly join the edges of the base layer.

6. The rubber sleeve of claim 1 wherein the abutting edges of the functional layer have no gap between them.

7. The rubber sleeve of claim 1 wherein the abutting edges of the functional layer are not joined.

8. The rubber sleeve of claim 1 wherein the abutting edges of the functional layer have a gap between them.

9. The rubber sleeve of claim 8 wherein said gap is filled with a sealing material which does not firmly join the edges of the functional layer.

10. The rubber sleeve of claim 1 wherein the abutting edges of the base layer and the abutting edges of the functional layer are offset from each other by an angle of 10° to 350°.

11. The rubber sleeve of claim 10 wherein the abutting edges of the base layer and the abutting edges of the functional layer are offset from each other by an angle of 40° to 320°.

12. The rubber sleeve of claim 11 wherein the abutting edges of the base layer and the abutting edges of the functional layer are offset from each other by an angle of 90° to 270°.

13. The rubber sleeve of claim 12 wherein the abutting edges of the base layer and the abutting edges of the functional layer are offset from each other by an angle of about 180°.

14. The rubber sleeve of claim 1 further comprising a bonding layer applied between the base layer and the functional layer.

15. The rubber sleeve of claim 1 wherein the base layer and the functional layer are joined by one of adhesive bonding, welding, and vulcanizing.

16. The rubber sleeve of claim 1 wherein the abutting edges of the base layer and the abutting edges of the functional layer both run substantially parallel to the axis.

17. The rubber sleeve of claim 1 wherein the abutting edges of the functional layer run substantially parallel to the axis, whereas the abutting edges of the base layer run at an acute angle to the axis.

18. The rubber sleeve of claim 17 wherein the base layer is formed by helical windings of a strip.

19. A method for producing a rubber sleeve of a printing press, the method comprising:
producing a first flat blank;
forming the first flat blank into a cylindrically shaped base layer having abutting edges;
producing a second flat blank; and
forming the second flat blank around the cylindrically shaped base layer to produce a cylindrically shaped functional layer having abutting edges which are circumferentially offset from the abutting edges of the base layer.
